(19) United States
(12) Patent Application Publication
(10) Pub. No.: US 2022/0262241 A1
(43) Pub. Date: Aug. 18, 2022

(54) SYSTEM AND METHOD FOR GENERATING AND INSPECTING TRAFFIC CONTROL MANAGEMENT

(71) Applicant: ConeIQtrack, Sterling, VA (US)

(72) Inventors: Wamiq Hamid, Sterling, VA (US); Uzair Ahmed Siddiqui, Sterling, VA (US)

(21) Appl. No.: 17/589,917

(22) Filed: Feb. 1, 2022

Related U.S. Application Data
(60) Provisional application No. 63/144,003, filed on Feb. 1, 2021.

(51) Int. Cl. G08G 1/01; G08G 1/0967; G06Q 10/06

(52) U.S. Cl. CPC G08G 1/0141; G06Q 10/0633; G08G 1/096783; G08G 1/0125

(57) ABSTRACT

A system and method for generating and inspecting traffic control management is disclosed. The includes receiving work zone data for a worksite location and determining one or more traffic control parameters associated with the worksite location. The method further includes generating a traffic control plan based on the work zone data, the one or more traffic control parameters, prestored guidelines, one or more custom parameters and set of design rules and deploying the generated traffic control plan at the worksite location. Further, the method includes obtaining real time worksite information and detecting one or more errors in the deployed traffic control plan. The method includes generating one or more recommendations corresponding to the detected one or more errors and outputting the detected one or more errors and the generated one or more recommendations on user interface screen of the one or more user devices.

### EARLIEST PRIORITY DATE

This application claims priority from a Provisional patent application filed in the United States of America having Patent Application No. 63/144,003, filed on Feb. 1, 2021, and titled “SYSTEM AND METHOD FOR THE DESIGN AND INSPECTION OF TRAFFIC CONTROL MANAGEMENT”.

### FIELD OF INVENTION

Embodiments of the present disclosure relate to traffic management systems and more particularly relates to a system and method for generating and inspecting traffic control management.

### BACKGROUND

In order to meet compliance with Work Health and Safety Act, local government, road construction organizations and public utility authorities are required to design, approve, and implement traffic control plans. When construction, maintenance and special events suspend or interrupt normal function of roadway, a traffic control plan is developed to ensure safety of all road passengers and workers at worksite location. The traffic control plan shows how traffic may be safely separated from the workers at the worksite location or work route. The traffic control plan is an instruction for site/road crews and is usually in the form of a diagram showing road conditions, such as lanes, signs and the like. Further, the traffic control plan also shows how the traffic is to be managed around the worksite location by performing one or more activities, such as temporary signs, posting of traffic control staff and the like. Generally, Traffic control plans are detailed drawings that show layout of temporary road signs and devices to warn and guide the traffic to pass around and through the worksite location safely.

There are multiple conventional techniques of generating the traffic control plans. However, the conventional techniques provide static and non-flexible traffic control plans which cannot be further customized based on changing situations at the worksite location. For example, in cases, where there are changes in design requirements, conventional traffic control plans are required to be manually generated again by considering current road and work constraints. Thus, the conventional techniques are complex and consume a lot of time of plan designers. Further, the conventional techniques provide generic design tools which take no consideration about the federal and state design rules, such as Manual on Uniform Traffic Control Device (MUTCD) or rules issued by states, utilities and the like. Thus, the conventional techniques are completely dependent on end-users to know all applicable design criteria. Furthermore, in the conventional techniques, the end users are required to physically visit the worksites to conduct safety audits and observe worksite layout without any objective data collection. Thus, the end users are required to perform huge number of manual tasks which may be error prone and inaccurate.

Hence, there is a need for a system and method for generating and inspecting traffic control management, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system for generating and inspecting traffic control management is disclosed. The computing system includes one or more hardware processors and a memory coupled to the one or more hardware processors. The memory includes a plurality of modules in the form of programmable instructions executable by the one or more hardware processors. The plurality of modules include a data receiver module configured to receive work zone data for a worksite location from at least one of: one or more user devices and a set of existing worksite resources at the worksite location. The work zone data includes: worksite location information, Temporary Traffic Control (TTC) information and direction of closure. The plurality of modules also include a parameter determination module configured to determine one or more traffic control parameters associated with the worksite location based on the received work zone data, prestored guidelines, one or more custom parameters associated with the worksite location and a set of design rules. The prestored guidelines include at least one of: Manual on Uniform Traffic Control Devices for Streets and Highways (MUTCD), state, local, utilities and customer guidelines. The plurality of modules include a plan generation module configured to automatically generate a traffic control plan for the worksite location based on the received work zone data, the determined one or more traffic control parameters, the prestored guidelines, the one or more custom parameters and the set of design rules. The traffic control plan is an interactive and customizable virtual map of the worksite location indicating at least one of: design layout of the worksite location, one or more worksite resources, locations of the one or more worksite resources, distance between each of the one or more worksite resources, one or more roads connecting the one or more worksite resources, shape and size of the one or more roads, start and stop time of the worksite zone, distance between each of the one or more roads, time of placement of the one or more worksite resources and image recognition of the one or more worksite resources. Further, the plurality of modules include a plan deploying module configured to deploy the generated traffic control plan at the worksite location. Furthermore, the plurality of modules include a data obtaining module configured to obtain real time worksite information associated with the worksite location upon deployment of the generated traffic control plan via one or more means. The real time worksite information includes: real-time images of the worksite location, real-time Maintenance of Traffic (MOT) start and stop time, real-time distance between each of the one or more worksite resources and real-time location information of the one or more worksite resources. The plurality of modules further include an error detection module configured to detect one or more errors in the deployed traffic control plan by validating the deployed traffic control plan based on the prestored guidelines, the one or more custom parameters, the set of design rules, the generated traffic control plan and the obtained real time worksite information. Further, the plurality of modules include a recommendation generation module configured to generate one or more recommendations corresponding to the detected one or more errors based on the prestored guidelines, the one or more custom parameters, the set of design rules, the generated traffic control plan and the obtained real time worksite information. The plurality of modules include a data output module configured to output the detected one or more errors and the generated one or more recommendations on user interface screens of the one or more user devices.

In accordance with another embodiment of the present disclosure, a method for generating and inspecting traffic control management is disclosed. The method includes receiving work zone data for a worksite location from at least one of: one or more user devices and a set of existing worksite resources at the worksite location. The work zone data includes: worksite location information, Temporary Traffic Control (TTC) information and direction of closure. The method also includes determining one or more traffic control parameters associated with the worksite location based on the received work zone data, prestored guidelines, one or more custom parameters associated with the worksite location and a set of design rules. The prestored guidelines include at least one of: Manual on Uniform Traffic Control Devices for Streets and Highways (MUTCD), state, local, utilities and customer guidelines. The method further includes automatically generating a traffic control plan for the worksite location based on the received work zone data, the determined one or more traffic control parameters, the prestored guidelines, the one or more custom parameters and the set of design rules. The traffic control plan is an interactive and customizable virtual map of the worksite location indicating at least one of: design layout of the worksite location, one or more worksite resources, locations of the one or more worksite resources, distance between each of the one or more worksite resources, one or more roads connecting the one or more worksite resources, shape and size of the one or more roads, start and stop time of the worksite zone, distance between each of the one or more roads, time of placement of the one or more worksite resources and image recognition of the one or more worksite resources. Further, the method includes deploying the generated traffic control plan at the worksite location. Also, the method includes obtaining real time worksite information associated with the worksite location upon deployment of the generated traffic control plan via one or more means. The real time worksite information includes: real-time images of the worksite location, real-time Maintenance of Traffic (MOT) start and stop time, real-time distance between each of the one or more worksite resources and real-time location information of the one or more worksite resources. Furthermore, the method includes detecting one or more errors in the deployed traffic control plan by validating the deployed traffic control plan based on the prestored guidelines, the one or more custom parameters, the set of design rules, the generated traffic control plan and the obtained real time worksite information. Further, the method includes generating one or more recommendations corresponding to the detected one or more errors based on the prestored guidelines, the one or more custom parameters, the set of design rules, the generated traffic control plan and the obtained real time worksite information. The method includes outputting the detected one or more errors and the generated one or more recommendations on user interface screens of the one or more user devices.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for generating and inspecting traffic control management, in accordance with an embodiment of the present disclosure;

FIG. 2 is a block diagram illustrating an exemplary computing system for generating and inspecting the traffic control management, in accordance with an embodiment of the present disclosure;

FIG. 3 is a process flow diagram illustrating an exemplary method for generating and inspecting the traffic control management, in accordance with an embodiment of the present disclosure;

FIG. 4 is an exemplary table illustrating one or more traffic control devices, in accordance with an embodiment of the present disclosure; and

FIGS. 5A-5B are graphical user interface screens of the computing system for generating and inspecting the traffic control management, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

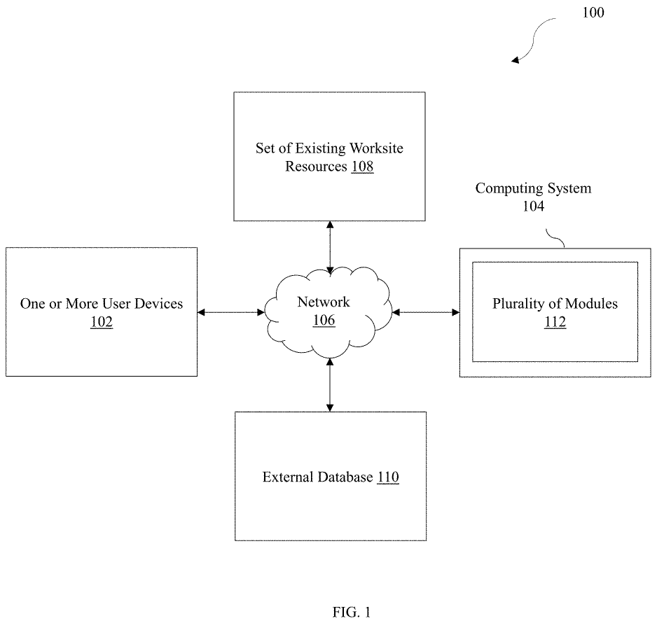

Referring now to the drawings, and more particularly to FIG. 1 through FIG. 5B, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 for generating and inspecting traffic control management, in accordance with an embodiment of the present disclosure. The traffic Control Management is designing, auditing and implementation of traffic control plans at worksite locations. According to FIG. 1, the computing environment 100 includes one or more user devices 102 associated with one or more users communicatively coupled to a computing system 104 via a network 106. In an exemplary embodiment of the present disclosure, the one or more users may be worksite workers, managers, government officials, designers and the like. The one or more user devices 102 are used by the one or more users to provide work zone data to the computing system 104. In an exemplary embodiment the present disclosure, the work zone data include worksite location information, Temporary Traffic Control (TTC) information, direction of closure and the like. The one or more user devices 102 may also be used by the one or more users to receive a traffic control plan generated by the computing system 104. Further, the one or more users may also receive one or more errors in deployed traffic control plan and one or more recommendations corresponding to the one or more errors via the one or more user devices 102. In an exemplary embodiment of the present disclosure, the one or more user devices 102 may include a laptop computer, desktop computer, tablet computer, smartphone, wearable device, smart watch, a digital camera and the like. Further, the network 106 may be internet, Wireless Fidelity (WI-FI), cloud connectivity, satellite communication and the like. The computing system 104 may be hosted on a central server, such as cloud server or a remote server.

Further, the computing environment 100 includes a set of existing worksite resources 108 at a worksite location communicatively coupled to the computing system 104 via the network 106. For example, the worksite location is a location where construction, maintenance and special events suspend or interrupt normal function of a roadway. In an exemplary embodiment of the present disclosure, the set of existing worksite resources 108 include one or more traffic control devices, one or more traffic sign boards, one or more site crew members, one or more image capturing units, one or more network terminals, one or more roads, road infrastructure, one or more vehicles and the like. In an exemplary embodiment of the present disclosure, the one or more traffic control devices include warning signs, safety cones, and the like. For example, the warning signs may include road work, left merge, share the road, right arrow, bike sign and the like. In an exemplary embodiment of the present disclosure, the one or more vehicles may be autonomous vehicles. In an embodiment of the present disclosure, the set of existing worksite resources 108 are configured to provide the work zone data to the computing system 104. The one or more network terminals are devices that takes a telecommunication network and connects to the set of existing worksite resources 108. In an exemplary embodiment of the present disclosure, the one or more network terminals may be a dedicated box, such as a router or a gateway. In another exemplary embodiment of the present disclosure, the one or more network terminals may be a multi-purpose unit including network connectivity along with other capabilities, such as Global Positioning System (GPS) receiver, transmitter or a Radio Frequency Identification (RFID) system. Although, FIG. 1 illustrates the computing system 104 communicatively coupled to the set of existing worksite resources 108 at the worksite location, one skilled in the art can envision that the computing system 104 may be connected to other worksite resources at multiple work site locations via the network 106.

In an embodiment of the present disclosure, the computing environment 100 includes an external database 110 communicatively coupled to the computing system 104 via the network 106. The external database 110 stores prestored guidelines, one or more custom parameters associated with the worksite location and a set of design rules. In an exemplary embodiment of the present disclosure, the prestored guidelines include Manual on Uniform Traffic Control Devices for Streets and Highways (MUTCD), state, local, utilities, customer guidelines or any combination thereof. Further, the one or more custom parameters are specific parameters corresponding to the worksite location. In an exemplary embodiment of the present disclosure, the one or more custom parameters include closure side, lane width, shoulder width and the like. In an exemplary embodiment of the present disclosure, the set of design rules are design rules associated with the worksite location collated from customers, federal, state, and local governments, utility companies, and the like.

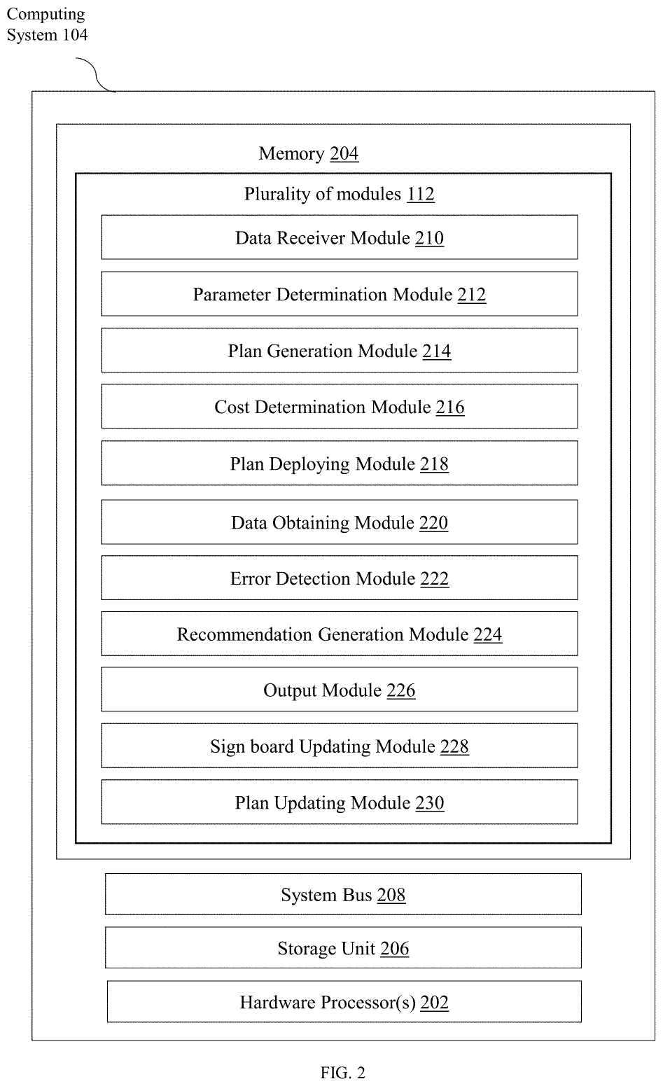

Further, the one or more user devices 102 include a local browser, a mobile application or a combination thereof. Furthermore, the one or more users may use a web application via the local browser, the mobile application or a combination thereof to communicate with the computing system 104. In an embodiment of the present disclosure, the one or more user devices 102 may access cloud applications for providing performance visualization of the set of existing worksite resources 108. In an embodiment of the present disclosure, the one or more users use the mobile application, the web application, or a combination thereof to enter work zone address and select a pertinent temporary traffic control design. Further, the one or more users confirm automatically collected site features and parameters. The mobile application, the web application, or a combination thereof then automatically lays out a traffic control plan on an online map. In an embodiment of the present disclosure, the computing system 104 includes a plurality of modules 112. Details on the plurality of modules 112 have been elaborated in subsequent paragraphs of the present description with reference to FIG. 2A.

Those of ordinary skilled in the art will appreciate that the hardware depicted in FIG. 1 may vary for particular implementations. For example, other peripheral devices such as an optical disk drive and the like, Local Area Network (LAN), Wide Area Network (WAN), Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

In an embodiment of the present disclosure, the computing system 104 is configured to receive the work zone data for the worksite location from the one or more user devices 102, the set of existing worksite resources 108 at the worksite location or a combination thereof. Further, the computing system 104 determines one or more traffic control parameters associated with the worksite location based on the received work zone data, the prestored guidelines, the one or more custom parameters associated with the worksite location and the set of design rules. The computing system 104 automatically generates the traffic control plan for the worksite location based on the received work zone data, the determined one or more traffic control parameters, the prestored guidelines, the one or more custom parameters and the set of design rules. Furthermore, the computing system 104 deploys the generated traffic control plan at the worksite location. The computing system 104 obtains real time worksite information associated with the worksite location upon deployment of the generated traffic control plan via one or more means. The computing system 104 also detects the one or more errors in the deployed traffic control plan by validating the deployed traffic control plan based on the prestored guidelines, the one or more custom parameters, the set of design rules, the generated traffic control plan and the obtained real time worksite information. Further, the computing system 104 generates the one or more recommendations corresponding to the detected one or more errors based on the prestored guidelines, the one or more custom parameters, the set of design rules, the generated traffic control plan and the obtained real time worksite information. The computing system 104 outputs the detected one or more errors and the generated one or more recommendations on user interface screens of the one or more user devices 102.

FIG. 2 is a block diagram illustrating an exemplary computing system 104 for generating and inspecting the traffic control management, in accordance with an embodiment of the present disclosure. Further, the computing system 104 includes one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 112 in the form of programmable instructions executable by the one or more hardware processors 202. Further, the plurality of modules 112 include a data receiver module 210, a parameter determination module 212, a plan generation module 214, a cost determination module 216, a plan deploying module 218, a data obtaining module 220, an error detection module 222, a recommendation generation module 224, an output module 226, a sign board updating module 228 and a plan updating module 230.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 112 stored in the form of machine-readable instructions on any of the above-mentioned storage media and may be in communication with and executed by the one or more hardware processors 202.

The storage unit 206 may be a cloud storage. The storage unit 206 may store the work zone data, the one or more traffic control parameters, the traffic control plan, the real time worksite information associated with the worksite location, a traffic control device icon library, the one or more errors in the deployed traffic control plan, the one or more recommendations, the worksite resource information, road geometry, virtual road design, one or more customized inputs, prestored error information, prestored cost information and updated traffic control plan. In an embodiment of the present disclosure, the storage unit may also store the prestored guidelines, the one or more custom parameters associated with the worksite location and the set of design rules. In another embodiment of the present disclosure, the external database 110 may store the prestored guidelines, the one or more custom parameters associated with the worksite location and the set of design rules.

The data receiver module 210 is configured to receive the work zone data for the worksite location from the one or more user devices 102, the set of existing worksite resources 108 at the worksite location or a combination thereof. For example, the worksite location is a location where construction, maintenance and special events suspend or interrupt normal function of a roadway. In an embodiment of the present disclosure, the one or more users may provide the work zone data to the computing system 104 via the one or more user devices 102. In an exemplary embodiment of the present disclosure, the work zone data may include worksite location information, Temporary Traffic Control (TTC) information, direction of closure and the like. In an exemplary embodiment of the present disclosure, the TTC information include designs based on Manual on Uniform Traffic Control Devices for Streets and Highways (MUTCD), state, local, utilities and other custom rules. Further, the direction of closure refers to cardinal direction in which one or more roads at the worksite location may be closed. In an exemplary embodiment of the present disclosure, the cardinal direction may be east, west, north or south. In an exemplary embodiment of the present disclosure, the one or more user devices 102 may include a laptop computer, desktop computer, tablet computer, smartphone, wearable device, smart watch, a digital camera and the like. In an exemplary embodiment of the present disclosure, the set of existing worksite resources 108 include one or more traffic control devices, one or more traffic sign boards, one or more site crew members, one or more image capturing units, one or more network terminals, one or more roads, road infrastructure, one or more vehicles and the like. In an exemplary embodiment of the present disclosure, the one or more traffic control devices include warning signs, safety cones and the like. For example, the warning signs may include road work, left merge, share the road, right arrow, bike sign and the like. The one or more network terminals are devices that takes a telecommunication network and connects to the set of existing worksite resources 108. In an exemplary embodiment of the present disclosure, the one or more network terminals may be a dedicated box, such as a router or a gateway. In another exemplary embodiment of the present disclosure, the one or more network terminals may be a multi-purpose unit including network connectivity along with other capabilities, such as Global Positioning System (GPS) receiver, transmitter or a Radio Frequency Identification (RFID) system. In an exemplary embodiment of the present disclosure, the one or more image capturing units include digital camera, drones, telescopic arms, blimps and the like.

The parameter determination module 212 is configured to determine the one or more traffic control parameters associated with the worksite location based on the received work zone data, the prestored guidelines, the one or more custom parameters associated with the worksite location and the set of design rules. In an exemplary embodiment of the present disclosure, the one or more custom parameters are user inputs corresponding to the worksite location. The one or more custom parameters include closure side, lane width, shoulder width and the like. In an exemplary embodiment of the present disclosure, the prestored guidelines include the MUTCD, state, local, utilities, customer guidelines or any combination thereof. In an exemplary embodiment of the present disclosure, the one or more traffic control parameters include the set of road characteristics of one or more roads, one or more required traffic control devices, distance between each of the one or more required traffic control devices, location coordinates of one or more required traffic sign boards on the one or more roads, the one or more worksite resources required at the worksite location, locations of the one or more worksite resources, distance between each of the one or more worksite resources and the like. The location coordinates may be latitude and longitude on the one or more roads at which each of the one or more required traffic sign boards is to be placed. In an embodiment of the present disclosure, exact location coordinates of the one or more required traffic sign boards may be determined using any one or more location detection system, such as geographic information system (GIS), global positioning system (GPS) and the like. In an embodiment of the present disclosure, the one or more traffic control parameters may also include date and time of placement of the one or more traffic control devices at the worksite location and one or more images of the one or more traffic control devices at the worksite location. The one or more required traffic control devices may vary based on the worksite location. In an embodiment of the present disclosure, the one or more required traffic control devices are determined based on one or more pre-stored MUTCD, state, local, utilities, or customer guidelines stored in the external database 110. Further, the set of road characteristics may include type of the one or more roads, shape of the one or more roads, size of the one or more roads, distance between each of the one or more roads, speed limit, shoulder width, lane width and the like. In an exemplary embodiment of the present disclosure, the type of the one or more roads may be highway, crossroad, exit road, intersection road, entry road and the like.

In determining the one or more traffic control parameters associated with the worksite location based on the received work zone data, the prestored guidelines, the one or more custom parameters associated with the worksite location and the set of design rules, the parameter determination module 212 retrieves the worksite resource information from the traffic control device icon library stored in the storage unit based on the received work zone data. In an exemplary embodiment of the present disclosure, the worksite resource information includes one or more device images of one or more traffic control devices placed at the worksite location. The parameter determination module 212 obtains the road geometry associated with the one or more roads from a Geographic Information System (GIS). Further, the parameter determination module 212 determines the set of road characteristics associated with the one or more roads based on the obtained geometry of the one or more roads, the prestored guidelines, the one or more custom parameters, the set of design rules and the received work zone data. The parameter determination module 212 also determines the one or more required traffic control devices and distance between each of the one or more required traffic control devices based on the received work zone data, the prestored guidelines, the one or more custom parameters, the set of design rules and the retrieved worksite resource information. Furthermore, the parameter determination module 212 determines location coordinates of the one or more required traffic sign boards based on the received work zone data, the prestored guidelines, the one or more custom parameters and the set of design rules. The parameter determination module 212 determines the one or more worksite resources, location of the one or more worksite resources and distance between each of the one or more worksite resources based on the received work zone data, the prestored guidelines, the one or more custom parameters, the set of design rules and the retrieved worksite resource information.

The plan generation module 214 is configured to automatically generate the traffic control plan for the worksite location based on the received work zone data, the determined one or more traffic control parameters, the prestored guidelines, the one or more custom parameters and the set of design rules. In an embodiment of the present disclosure, the traffic control plan is an interactive and customizable virtual map of the worksite location indicating design layout of the worksite location including warning area, transition area, buffer area, activity area, termination area and the like, one or more worksite resources, locations of the one or more worksite resources, distance between each of the one or more worksite resources, one or more roads connecting the one or more worksite resources, shape and size of the one or more roads, start and stop time of the worksite zone, distance between each of the one or more roads, time of placement of the one or more worksite resources, image recognition of the one or more worksite resources or any combination thereof. The one or more users capture one or more images of the one or more worksite resources at the worksite location. Further, the captured one or more images are compared with a database developed using computer vision technology for the image recognition of the one or more worksite resources. The computing system may provide alerts if the captured one or more images do not match within a predefined tolerance based on the comparison. In another embodiment of the present disclosure, the traffic control plan is an interactive and customizable online map. In an embodiment of the present disclosure, the traffic control plan also includes a tabular output with color coded alerts associated with the one or more worksite resources. Further, pertinent cells in tabular format and road on the online map may be color coded to indicate deviation from the compliance. In an exemplary embodiment of the present disclosure, the locations of the one or more worksite resources may be in the form of latitude and longitude coordinates, such that the one or more worksite resources may be easily placed at the determined locations. In automatically generating the traffic control plan for the worksite location based on the received work zone data, the determined one or more traffic control parameters, the prestored guidelines, the one or more custom parameters and the set of design rules, the plan generation module 214 generates the virtual road design of the one or more roads based on the determined set of road characteristics, the received work zone data, the determined one or more traffic control parameters, the prestored guidelines, the one or more custom parameters and the set of design rules. Further, the plan generation module 214 superimposes the generated virtual road design on the design layout of the worksite location. In an embodiment of the present disclosure, the plan generation module 214 automatically draws the one or more roads on top of an online map to generate and superimpose the virtual road design on the design layout of the worksite location. Thus, the one or more users may easily view lane level details of the one or more roads which may be obscured on satellite imagery.

The cost determination module 216 is configured to determine an accurate inventory and cost of the one or more required traffic control devices used at the worksite location based on the prestored cost information. Further, the determined accurate inventory and cost of the one or more required traffic control devices are outputted on user interface screens of the one or more user devices 102.

In an embodiment of the present disclosure, the generated traffic control plan is outputted on user interface screens of the one or more user devices 102, printed via one or more printing devices, converted to one or more other formats, outputted to one or more secondary platforms or any combination thereof. In an exemplary embodiment of the present disclosure, the one or more formats may be Portable Document Format (PDF), image format and the like. The generated traffic control plan is outputted on user interface screens of the one or more user devices 102 via text message, email, mobile application, web application and the like. In an embodiment of the present disclosure, training is provided to the one or more users by using different design layouts on online road and highway maps, such that the one or more users may easily understand the generated traffic control plan. In an exemplary embodiment of the present disclosure, the one or more secondary platform includes one or more designing tools, one or more navigation applications, travel advisory signs, one or more autonomous vehicles, one or more mobile applications and the like. In an exemplary embodiment of the present disclosure, the generated traffic control plan is outputted to the one or more secondary platforms via Application Programming Interface (API). Further, outputting the generated traffic control plan on user interface screens of the one or more user devices 102 includes displaying the generated traffic control plan on the user interface screens. In an embodiment of the present disclosure, the generated traffic control plan is shared with the one or more secondary platforms for work zone data exchange.

The plan deploying module 218 is configured to deploy the generated traffic control plan at the worksite location. In an embodiment of the present disclosure, when the generated traffic control plan is approved by concerned authorities, the generated traffic control plan is deployed at the worksite location.

The data obtaining module 220 is configured to obtain the real time worksite information associated with the worksite location upon deployment of the generated traffic control plan via one or more means. In an exemplary embodiment of the present disclosure, the one or more means include the one or more user devices 102, the one or more worksite resources, a Global Position System (GPS), a Geographic Information System (GIS), a Radio Frequency Identification (RFID) device, Light Detection and Ranging (LiDAR), one or more image capturing units or any combination thereof. In an exemplary embodiment of the present disclosure, the real time worksite information includes real-time images of the worksite location, real-time Maintenance of Traffic (MOT) start and stop time, real-time distance between each of the one or more worksite resources, real-time location information of the one or more worksite resources and the like. For example, the GPS and the RFID device is used for obtaining the real-time location information of the one or more worksite resources. In an embodiment of the present disclosure, the real-time images of the worksite location from all dimensions are captured along with location, date and time stamp information. In an exemplary embodiment of the present disclosure, the real-time images of the worksite location are captured using the one or more image capturing units installed at the worksite location, through camera of the one or more user devices 102 or any other means such as, cameras mounted on vehicles or at the worksite location. Further, the real-time images of the worksite location may also be captured using the LiDAR system. In an embodiment of the present disclosure, the real-time MOT start and stop time may also be captured through the one or more sensor devices or provided by the one or more users via the one or more user devices 102. In an exemplary embodiment of the present disclosure, the distance between each of the one or more worksite resources may be calculated by using any standard distance calculation means. In an embodiment of the present disclosure, a tabular output including the calculated distance is generated. For example, the standard distance calculation means may be great circle formula.

The error detection module 222 is configured to detect the one or more errors in the deployed traffic control plan by validating the deployed traffic control plan based on the prestored guidelines, the one or more custom parameters, the set of design rules, the generated traffic control plan and the obtained real time worksite information. In detecting the one or more errors in the deployed traffic control plan by validating the deployed traffic control plan based on the prestored guidelines, the one or more custom parameters, the set of design rules, the generated traffic control plan and the obtained real time worksite information, the error detection module 222 compares the obtained real time worksite information associated with the worksite location with the prestored guidelines, the one or more custom parameters, the set of design rules and the generated traffic control plan. Further, the error detection module 222 determines one or more differences between the obtained real time worksite information and the prestored guidelines, the one or more custom parameters, the set of design rules and the generated traffic control plan based on result of the comparison. The error detection module 222 detects the one or more errors in the deployed traffic control plan based on the determined one or more differences and prestored error information. In an embodiment of the present disclosure, the determined one or more differences and the detected one or more errors are outputted on user interface screens of the one or more user devices 102 as alerts. In another embodiment of the present disclosure, the determined one or more differences and the detected one or more errors are outputted on user interface screens of the one or more user devices 102 in a report. In an exemplary embodiment of the present disclosure, the report may be in Portable Document Format (pdf), word format, image format, and the like. In an embodiment of the present disclosure, the one or more differences represent unsuccessful validation of the deployed traffic control plan. Further, when no differences are determined between the obtained real time worksite information and the prestored guidelines, the one or more custom parameters, the set of design rules and the generated traffic control plan, it represents successful validation of the deployed traffic control plan. In an embodiment of the present disclosure, the traffic control plan is outputted on user interface screens of the one or more user devices 102 upon successful validation of the deployed traffic control plan.

The recommendation generation module 224 is configured to generate the one or more recommendations corresponding to the detected one or more errors based on the prestored guidelines, the one or more custom parameters, the set of design rules, the generated traffic control plan and the obtained real time worksite information. In an exemplary embodiment of the present disclosure, the one or more recommendations include correct location of the one or more worksite resources, correct distance between each of the one or more worksite resources, correct time stamp, total number of worksite resources required to be added or removed from the worksite location and the like.

The data output module 226 is configured to output the detected one or more errors and the generated one or more recommendations on user interface screens of the one or more user devices 102.

In an embodiment of the present disclosure, the sign board updating module 228 obtains one or more inputs corresponding to traffic at the worksite location via the one or more means upon deploying the generated traffic control plan at the worksite location. In an exemplary embodiment of the present disclosure, the one or more inputs may be one or more sensor readings, one or more real-time images of the traffic and the like. Further, the sign board updating module 228 determines direction of flow of the traffic at real-time based on the obtained one or more inputs. The sign board updating module 228 automatically updates location and direction of the one or more required traffic sign boards in the generated traffic control plan. Thus, the one or more required traffic sign boards always face the traffic on the generated traffic control plan.

The plan updating module 230 is configured to receive one or more customized inputs corresponding to one or more features of the generated traffic control plan. In an embodiment of the present disclosure, the one or more inputs are provided by performing one or more actions on the one or more user devices 102 including drag and drop, click, swipe up, swipe down, pinch, click, press and hold, double touch, stretch out and the like. In an exemplary embodiment of the present disclosure, the one or more features of the generated traffic control plan include movement of the one or more required traffic control devices, detection of exits, email notification, number of the one or more required traffic control devices, location of the one or more worksite resources, distance between each of the one or more worksite resources, location of the one or more required traffic control devices and the like. Further, the plan updating module 230 performs one or more customized actions on the generated traffic control plan based on the received one or more customized inputs. In an exemplary embodiment of the present disclosure, the one or more customized actions include updating work site design requirements, updating the one or more worksite resources, adjusting distances between the one or more worksite resources, updating location of each of the one or more worksite resources, updating the set of road characteristics and the like. Furthermore, the plan updating module 230 updates the generated traffic control plan based on the prestored guidelines, the one or more custom parameters and the set of design rules upon performing the one or more customized actions. In an embodiment of the present disclosure, the updated traffic control plan is deployed at the worksite location, outputted on user interface screens of the one or more user devices 102, printed via the one or more printing devices, converted to one or more other formats, outputted to the one or more secondary platforms or any combination thereof.

In operation, the computing system 104 receives the work zone data for the worksite location from the one or more user devices 102, the set of existing worksite resources 108 at the worksite location or a combination thereof. Further, the computing system 104 determines the one or more traffic control parameters associated with the worksite location based on the received work zone data, the prestored guidelines, the one or more custom parameters associated with the worksite location and the set of design rules. The computing system 104 automatically generates the traffic control plan for the worksite location based on the received work zone data, the determined one or more traffic control parameters, the prestored guidelines, the one or more custom parameters and the set of design rules. Furthermore, the computing system 104 deploys the generated traffic control plan at the worksite location. The computing system 104 obtains the real time worksite information associated with the worksite location upon deployment of the generated traffic control plan via one or more means. The computing system 104 detects the one or more errors in the deployed traffic control plan by validating the deployed traffic control plan based on the prestored guidelines, the one or more custom parameters, the set of design rules, the generated traffic control plan and the obtained real time worksite information. Further, the computing system 104 generates the one or more recommendations corresponding to the detected one or more errors based on the prestored guidelines, the one or more custom parameters, the set of design rules, the generated traffic control plan and the obtained real time worksite information. The computing system 104 outputs the detected one or more errors and the generated one or more recommendations on user interface screens of the one or more user devices 102.

In an embodiment of the present disclosure, the computing system automatically retrieves one or more traffic control parameters, such as highway types, posted speed, traffic flow direction and the like from an open-source database. Further, the computing system automatically generates a traffic control plan on an online map based on the one or more traffic control parameters and user provided information, such as work zone location and pertinent temporary traffic control design. With the help of the traffic control plan, the site crew installs the one or more worksite resources on the worksite location accordingly. Furthermore, the computing system captures the GPS locations of the one or more worksite resources using either smart phone or any other device. The computing system then compares the captured GPS locations of the one or more worksite resources on the worksite location with traffic control plan coordinates on the online map and provides an alert if deviation is more than preset deviation.

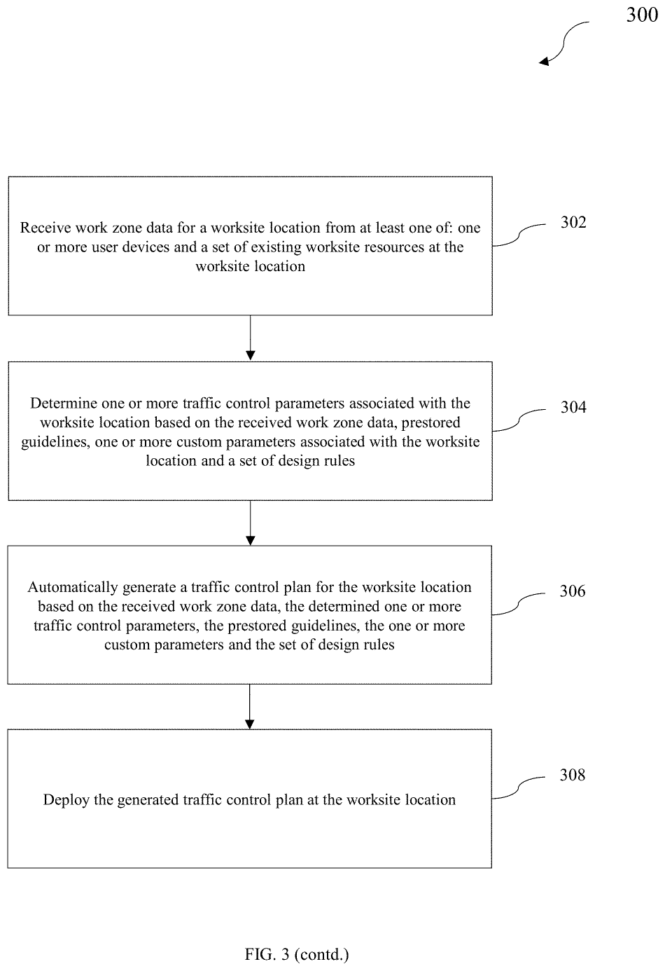

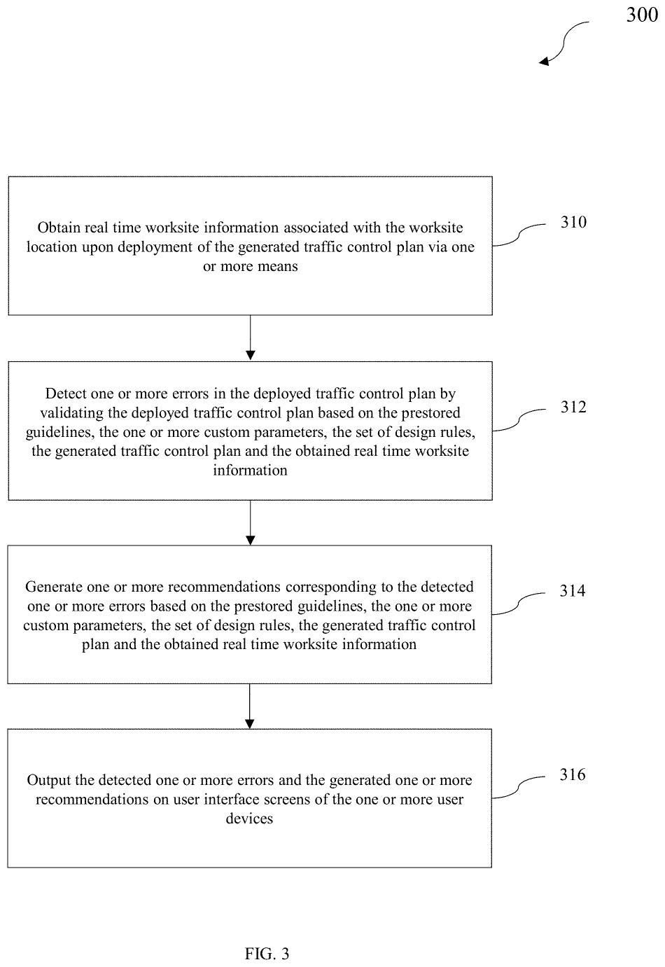

FIG. 3 is a process flow diagram illustrating an exemplary method for generating and inspecting the traffic control management, in accordance with an embodiment of the present disclosure. At step 302, work zone data for a worksite location is received from one or more user devices 102, a set of existing worksite resources 108 at the worksite location or a combination thereof. For example, the worksite location is a location where construction, maintenance and special events suspend or interrupt normal function of a roadway. In an embodiment of the present disclosure, the one or more users may provide the work zone data to the computing system 104 via the one or more user devices 102. In an exemplary embodiment of the present disclosure, the work zone data may include worksite location information, Temporary Traffic Control (TTC) information, direction of closure and the like. In an exemplary embodiment of the present disclosure, the TTC information include designs based on Manual on Uniform Traffic Control Devices for Streets and Highways (MUTCD), state, local, utilities and other custom rules. Further, the direction of closure refers to cardinal direction in which one or more roads at the worksite location may be closed. In an exemplary embodiment of the present disclosure, the cardinal direction may be east, west, north or south. In an exemplary embodiment of the present disclosure, the one or more user devices 102 may include a laptop computer, desktop computer, tablet computer, smartphone, wearable device, smart watch, a digital camera and the like. In an exemplary embodiment of the present disclosure, the set of existing worksite resources 108 include one or more traffic control devices, one or more traffic sign boards, one or more site crew members, one or more image capturing units, one or more network terminals, one or more roads, road infrastructure, one or more vehicles and the like. In an exemplary embodiment of the present disclosure, the one or more traffic control devices include warning signs, safety cones and the like. For example, the warning signs may include road work, left merge, share the road, right arrow, bike sign and the like. The one or more network terminals are devices that takes a telecommunication network and connects to the set of existing worksite resources 108. In an exemplary embodiment of the present disclosure, the one or more network terminals may be a dedicated box, such as a router or a gateway. In another exemplary embodiment of the present disclosure, the one or more network terminals may be a multi-purpose unit including network connectivity along with other capabilities, such as Global Positioning System (GPS) receiver, transmitter or a Radio Frequency Identification (RFID) system. In an exemplary embodiment of the present disclosure, the one or more image capturing units include digital camera, drones, telescopic arms, blimps and the like.

At step 304, one or more traffic control parameters associated with the worksite location are determined based on the received work zone data, prestored guidelines, one or more custom parameters associated with the worksite location and a set of design rules. In an exemplary embodiment of the present disclosure, the one or more custom parameters are user inputs corresponding to the worksite location. The one or more custom parameters include closure side, lane width, shoulder width and the like. In an exemplary embodiment of the present disclosure, the prestored guidelines include the MUTCD, state, local, utilities, customer guidelines or any combination thereof. In an exemplary embodiment of the present disclosure, the one or more traffic control parameters include the set of road characteristics of one or more roads, one or more required traffic control devices, distance between each of the one or more required traffic control devices, location coordinates of one or more required traffic sign boards on the one or more roads, the one or more worksite resources required at the worksite location, locations of the one or more worksite resources, distance between each of the one or more worksite resources and the like. The location coordinates may be latitude and longitude on the one or more roads at which each of the one or more required traffic sign boards is to be placed. In an embodiment of the present disclosure, exact location coordinates of the one or more required traffic sign boards may be determined using any one or more location detection system, such as geographic information system (GIS), global positioning system (GPS) and the like. In an embodiment of the present disclosure, the one or more traffic control parameters may also include date and time of placement of the one or more traffic control devices at the worksite location and one or more images of the one or more traffic control devices at the worksite location. The one or more required traffic control devices may vary based on the worksite location. In an embodiment of the present disclosure, the one or more required traffic control devices are determined based on one or more pre-stored MUTCD, state, local, utilities, or customer guidelines stored in the external database 110. Further, the set of road characteristics may include type of the one or more roads, shape of the one or more roads, size of the one or more roads, distance between each of the one or more roads, speed limit, shoulder width, lane width and the like. In an exemplary embodiment of the present disclosure, the type of the one or more roads may be highway, crossroad, exit road, intersection road, entry road and the like.

In determining the one or more traffic control parameters associated with the worksite location based on the received work zone data, the prestored guidelines, the one or more custom parameters associated with the worksite location and the set of design rules, the method 300 includes retrieving the worksite resource information from the traffic control device icon library stored in the storage unit based on the received work zone data. In an exemplary embodiment of the present disclosure, the worksite resource information includes one or more device images of one or more traffic control devices placed at the worksite location. The method 300 includes obtaining the road geometry associated with the one or more roads from a Geographic Information System (GIS). Further, the method 300 includes determining the set of road characteristics associated with the one or more roads based on the obtained geometry of the one or more roads, the prestored guidelines, the one or more custom parameters, the set of design rules and the received work zone data. The method 300 includes determining the one or more required traffic control devices and distance between each of the one or more required traffic control devices based on the received work zone data, the prestored guidelines, the one or more custom parameters, the set of design rules and the retrieved worksite resource information. Furthermore, the method 300 includes determining location coordinates of the one or more required traffic sign boards based on the received work zone data, the prestored guidelines, the one or more custom parameters and the set of design rules. The method 300 includes determining the one or more worksite resources, location of the one or more worksite resources and distance between each of the one or more worksite resources based on the received work zone data, the prestored guidelines, the one or more custom parameters, the set of design rules and the retrieved worksite resource information.

At step 306, a traffic control plan is automatically generated for the worksite location based on the received work zone data, the determined one or more traffic control parameters, the prestored guidelines, the one or more custom parameters and the set of design rules. In an embodiment of the present disclosure, the traffic control plan is an interactive and customizable virtual map of the worksite location indicating design layout of the worksite location including warning area, transition area, buffer area, activity area, termination area and the like, one or more worksite resources, locations of the one or more worksite resources, distance between each of the one or more worksite resources, one or more roads connecting the one or more worksite resources, shape and size of the one or more roads, start and stop time of the worksite zone, distance between each of the one or more roads, time of placement of the one or more worksite resources, image recognition of the one or more worksite resources or any combination thereof. In another embodiment of the present disclosure, the traffic control plan is an interactive and customizable online map. In an embodiment of the present disclosure, the traffic control plan also includes a tabular output with color coded alerts associated with the one or more worksite resources. Further, pertinent cells in tabular format and road on the online map may be color coded to indicate deviation from the compliance. In an exemplary embodiment of the present disclosure, the locations of the one or more worksite resources may be in the form of latitude and longitude coordinates, such that the one or more worksite resources may be easily placed at the determined locations. In automatically generating the traffic control plan for the worksite location based on the received work zone data, the determined one or more traffic control parameters, the prestored guidelines, the one or more custom parameters and the set of design rules, the method 300 includes generating the virtual road design of the one or more roads based on the determined set of road characteristics, the received work zone data, the determined one or more traffic control parameters, the prestored guidelines, the one or more custom parameters and the set of design rules. Further, the method 300 includes superimposing the generated virtual road design on the design layout of the worksite location. In an embodiment of the present disclosure, the method 300 includes automatically drawing the one or more roads on top of an online map to generate and superimpose the virtual road design on the design layout of the worksite location. Thus, the one or more users may easily view lane level details of the one or more roads which may be obscured on satellite imagery.

In an embodiment of the present disclosure, the method 300 includes determining an accurate inventory and cost of the one or more required traffic control devices used at the worksite location based on prestored cost information. Further, the determined accurate inventory and cost of the one or more required traffic control devices are outputted on user interface screens of the one or more user devices 102

In an embodiment of the present disclosure, the generated traffic control plan is outputted on user interface screens of the one or more user devices 102, printed via one or more printing devices, converted to one or more other formats, outputted to one or more secondary platforms or any combination thereof. In an exemplary embodiment of the present disclosure, the one or more formats may be Portable Document Format (PDF), image format and the like. The generated traffic control plan is outputted on user interface screens of the one or more user devices 102 via text message, email, mobile application, web application and the like. In an embodiment of the present disclosure, training is provided to the one or more users by using different design layouts on online road and highway maps, such that the one or more users may easily understand the generated traffic control plan. In an exemplary embodiment of the present disclosure, the one or more secondary platform includes one or more designing tools, one or more navigation applications, travel advisory signs, one or more autonomous vehicles, one or more mobile applications and the like. In an exemplary embodiment of the present disclosure, the generated traffic control plan is outputted to the one or more secondary platforms via Application Programming Interface (API). Further, outputting the generated traffic control plan on user interface screens of the one or more user devices 102 includes displaying the generated traffic control plan on the user interface screens. In an embodiment of the present disclosure, the generated traffic control plan is shared with the one or more secondary platforms for work zone data exchange.

At step 308, the generated traffic control plan is deployed at the worksite location. In an embodiment of the present disclosure, when the generated traffic control plan is approved by concerned authorities, the generated traffic control plan is deployed at the worksite location.

At step 310, real time worksite information associated with the worksite location is obtained upon deployment of the generated traffic control plan via one or more means. In an exemplary embodiment of the present disclosure, the one or more means include the one or more user devices 102, the one or more worksite resources, a Global Position System (GPS), a Geographic Information System (GIS), a Radio Frequency Identification (RFID) device, Light Detection and Ranging (LiDAR), one or more image capturing units or any combination thereof. In an exemplary embodiment of the present disclosure, the real time worksite information includes real-time images of the worksite location, real-time Maintenance of Traffic (MOT) start and stop time, real-time distance between each of the one or more worksite resources, real-time location information of the one or more worksite resources and the like. For example, the GPS and the RFID device is used for obtaining the real-time location information of the one or more worksite resources. In an embodiment of the present disclosure, the real-time images of the worksite location from all dimensions are captured along with location, date and time stamp information. In an exemplary embodiment of the present disclosure, the real-time images of the worksite location are captured using the one or more image capturing units installed at the worksite location, through camera of the one or more user devices 102 or any other means such as, cameras mounted on vehicles or at the worksite location. Further, the real-time images of the worksite location may also be captured using the LiDAR system. In an embodiment of the present disclosure, the real-time MOT start and stop time may also be captured through the one or more sensor devices or provided by the one or more users via the one or more user devices 102. In an exemplary embodiment of the present disclosure, the distance between each of the one or more worksite resources may be calculated by using any standard distance calculation means. In an embodiment of the present disclosure, a tabular output including the calculated distance is generated. For example, the standard distance calculation means may be great circle formula.

At step 312, one or more errors in the deployed traffic control plan are detected by validating the deployed traffic control plan based on the prestored guidelines, the one or more custom parameters, the set of design rules, the generated traffic control plan and the obtained real time worksite information. In detecting the one or more errors in the deployed traffic control plan by validating the deployed traffic control plan based on the prestored guidelines, the one or more custom parameters, the set of design rules, the generated traffic control plan and the obtained real time worksite information, the method 300 includes comparing the obtained real time worksite information associated with the worksite location with the prestored guidelines, the one or more custom parameters, the set of design rules and the generated traffic control plan. Further, the method 300 includes determining one or more differences between the obtained real time worksite information and the prestored guidelines, the one or more custom parameters, the set of design rules and the generated traffic control plan based on result of the comparison. The method 300 includes detecting the one or more errors in the deployed traffic control plan based on the determined one or more differences and prestored error information. In an embodiment of the present disclosure, the determined one or more differences and the detected one or more errors are outputted on user interface screens of the one or more user devices 102 as alerts. In another embodiment of the present disclosure, the determined one or more differences and the detected one or more errors are outputted on user interface screens of the one or more user devices 102 in a report. In an exemplary embodiment of the present disclosure, the report may be in Portable Document Format (pdf), word format, image format, and the like. In an embodiment of the present disclosure, the one or more differences represent unsuccessful validation of the deployed traffic control plan. Further, when no differences are determined between the obtained real time worksite information and the prestored guidelines, the one or more custom parameters, the set of design rules and the generated traffic control plan, it represents successful validation of the deployed traffic control plan. In an embodiment of the present disclosure, the traffic control plan is outputted on user interface screens of the one or more user devices 102 upon successful validation of the deployed traffic control plan.

At step 314, one or more recommendations corresponding to the detected one or more errors are generated based on the prestored guidelines, the one or more custom parameters, the set of design rules, the generated traffic control plan and the obtained real time worksite information. In an exemplary embodiment of the present disclosure, the one or more recommendations include correct location of the one or more worksite resources, correct distance between each of the one or more worksite resources, correct time stamp, total number of worksite resources required to be added or removed from the worksite location and the like.

At step 316, the detected one or more errors and the generated one or more recommendations are outputted on user interface screens of the one or more user devices 102.

In an embodiment of the present disclosure, the method 300 includes obtaining one or more inputs corresponding to traffic at the worksite location via the one or more means upon deploying the generated traffic control plan at the worksite location. In an exemplary embodiment of the present disclosure, the one or more inputs may be one or more sensor readings, one or more real-time images of the traffic and the like. Further, the method 300 includes determining direction of flow of the traffic at real-time based on the obtained one or more inputs. The method 300 includes automatically updating location and direction of the one or more required traffic sign boards in the generated traffic control plan. Thus, the one or more required traffic sign boards always face the traffic on the generated traffic control plan.

The method 300 includes receiving one or more customized inputs corresponding to one or more features of the generated traffic control plan. In an embodiment of the present disclosure, the one or more inputs are provided by performing one or more actions on the one or more user devices 102 including drag and drop, click, swipe up, swipe down, pinch, click, press and hold, double touch, stretch out and the like. In an exemplary embodiment of the present disclosure, the one or more features of the generated traffic control plan include movement of the one or more required traffic control devices, detection of exits, email notification, number of the one or more required traffic control devices, location of the one or more worksite resources, distance between each of the one or more worksite resources, location of the one or more required traffic control devices and the like. Further, the method 300 includes performing one or more customized actions on the generated traffic control plan based on the received one or more customized inputs. In an exemplary embodiment of the present disclosure, the one or more customized actions include updating work site design requirements, updating the one or more worksite resources, adjusting distances between the one or more worksite resources, updating location of each of the one or more worksite resources, updating the set of road characteristics and the like. Furthermore, the method 300 includes updating the generated traffic control plan based on the prestored guidelines, the one or more custom parameters and the set of design rules upon performing the one or more customized actions. In an embodiment of the present disclosure, the updated traffic control plan is deployed at the worksite location, outputted on user interface screens of the one or more user devices 102, printed via the one or more printing devices, converted to one or more other formats, outputted to the one or more secondary platforms or any combination thereof.

The method 300 may be implemented in any suitable hardware, software, firmware, or combination thereof.

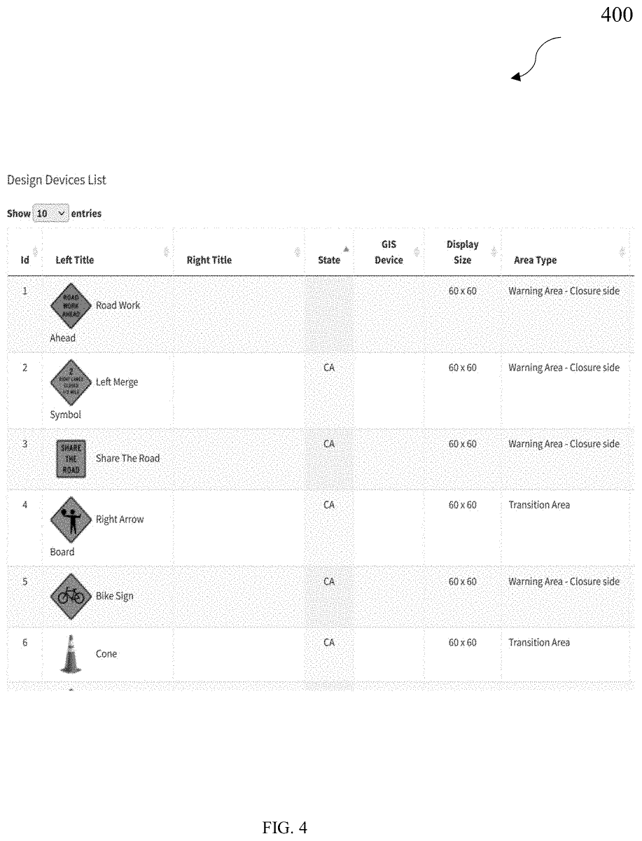

FIG. 4 is an exemplary table 400 illustrating one or more traffic control devices, in accordance with an embodiment of the present disclosure. The table 400 shows the one or more traffic control devices, such as road work, left merge, share the road and the like along with display size and area type associated with each of the one or more traffic control devices.

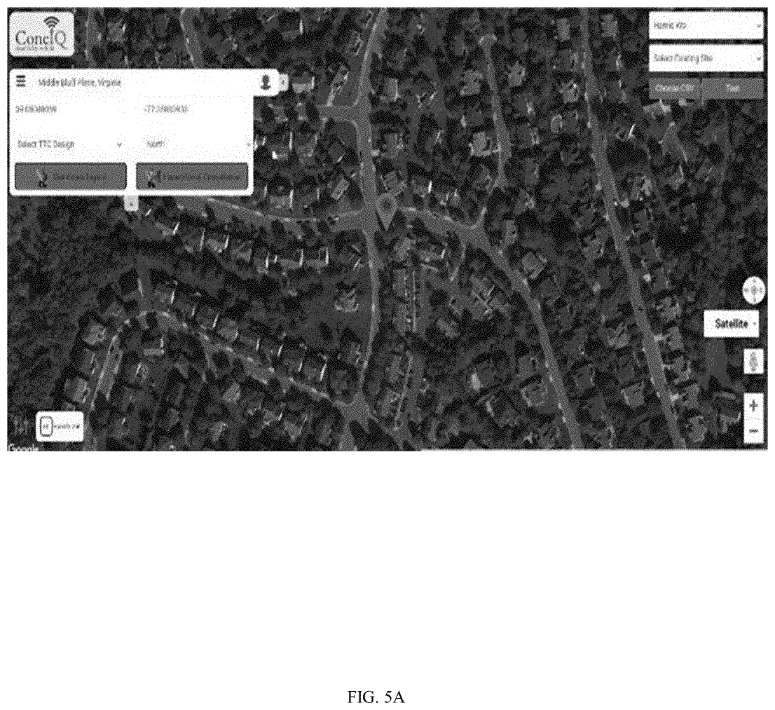

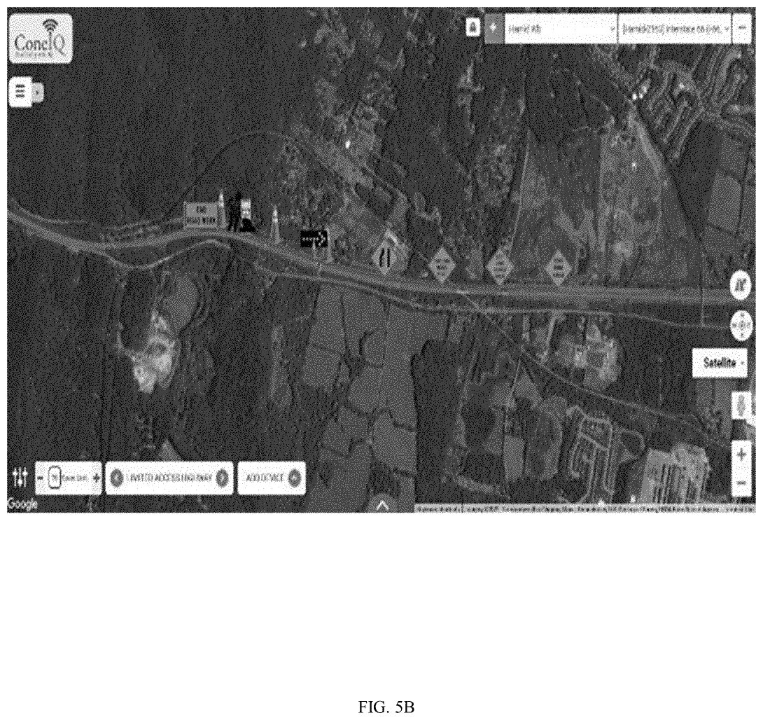

FIGS. 5A-5B are graphical user interface screens of the computing system for generating and inspecting the traffic control management, in accordance with an embodiment of the present disclosure. FIG. 5A is the online map showing the worksite location along with location coordinates of the worksite location. FIG. 5B is the traffic control plan on the online map. The traffic control plan is an interactive and customizable virtual map of the worksite location indicating design layout of the worksite location including warning area, transition area, buffer area, activity area, termination area and the like, the one or more worksite resources, locations of the one or more worksite resources, distance between each of the one or more worksite resources, one or more roads connecting the one or more worksite resources, shape and size of the one or more roads, start and stop time of the worksite zone, distance between each of the one or more roads, time of placement of the one or more worksite resources, or any combination thereof.

Thus, various embodiments of the present computing system 104 provide a solution to generate and inspect the traffic control management. The computing system 104 is dynamic and flexible in understanding design requirements of the worksite location and automatically generate the interactive and customizable the traffic control plan. Further, the computing system 104 simplifies generation of the traffic control plan and improves traffic control safety with a digital record of each of the one or more worksite resources. The computing system 104 automatically generates a site-specific traffic control plan on an online map within seconds and guides crew at the worksite location to navigate and set up each of the one or more traffic control devices at the correct location based on the Federal MUTCD as well as state, local, utilities, and custom design guidelines. Furthermore, the computing system 104 collects the locations of each of the one or more worksite resources and provides a comparison with the design requirements thus improving work zone safety and compliance while reducing liability. The computing system 104 codifies the temporary traffic control design requirements in its memory which is customizable to different site conditions. In an embodiment of the present disclosure, the computing system 104 has codified all the one or more traffic control parameters, the temporary traffic control design requirements, such as highway type, posted speed and the like and the one or more worksite resources, such that the traffic control plan may be generated automatically with all the one or more worksite resources and their distances without any manual calculations based on the one or more traffic control parameters The computing system 104 automatically generates an interactive traffic control plan in seconds on an online map using the one or more custom parameters. Further, the computing system 104 also determines the accurate inventory and cost of the one or more required traffic control devices used at the worksite location based on the prestored cost information. The traffic control plan including the online map guides the site crew to navigate to the worksite location to place the one or more required traffic sign boards on correct locations. The real-time location of the one or more worksite resources are recorded and compared with design requirements for verification. The generated traffic control plan may be shared with third parties to improve traffic flow such as for autonomous vehicles, navigational applications, for travel advisories and the like.

Further, the computing system 104 enables generation of standard and customized designs of the traffic control plan based on the set of road characteristics such as road type, speed, shoulder & lane width and road features such as exits, entrances, intersections, or driveways. The computing system 104 previews the traffic control plan, which may be used as maintenance of traffic (MOT) design layout, on an online map before site deployment. The computing system 104 also enables customization to the traffic control plan by allowing movement of the one or more worksite resources on the map to adjust for worksite constraints. Furthermore, the computing system 104 allows sharing traffic control plan with site crew having information including design layout of the worksite location, one or more worksite resources, locations of the one or more worksite resources, distance between each of the one or more worksite resources, one or more roads connecting the one or more worksite resources, shape and size of the one or more roads, start and stop time of the worksite zone, distance between each of the one or more roads, time of placement of the one or more worksite resources and image recognition of the one or more worksite resources. The system further allows placing the one or more worksite resources on the worksite location with the help of location coordinates. Further, the computing system 104 provides training to the one or more users using different design layouts on online road and highway maps. Additionally, the computing system 104 provides MOT reports for deviations and compliances record.

Furthermore, the computing system 104 provides timely alerts when the deployed traffic control plan deviates from designs. The computing system 104 system provides digital photo evidence of the worksite location start and stop times along with alerts when time is not in compliance with customer guidelines. Further, the computing system 104 enhances worksite location safety by enabling the one or more users to instantly generate the traffic control plan and giving the one or more users unparalleled planning capabilities. By viewing the traffic control plan ahead of time, crews can make necessary adjustments for particular site constraints as well as navigate to the precise location of each of the one or more required traffic control devices. Also, the computing system 104 helps the one or more users build and customize the traffic control plan instantly and use its tools to set up the worksite location correctly on site. The computing system 104 also helps avoid non-compliant work zones. Further, the computing system 104 allows the one or more users to audit and verify the compliance of the traffic control plan in accordance with the prestored guidelines, the one or more custom parameters, the set of design rules and the generated traffic control plan by using the real-time worksite information associated with the worksite location. The more compliant the work zone is, the safer it is going to be for everyone. Furthermore, audits are conducted on each work zone through a digital log of device placements with images along with distance comparison against the prestored guidelines, the one or more custom parameters and the set of design rules. Unlike the conventional systems which are highly dependent on manual, visual analysis with limited or no digital record of date, time, location and imagery/sensory data, the computing system 104 provides the tools to capture real time worksite information associated with the worksite location and compare them with the prestored guidelines, the one or more custom parameters, the set of design rules and the generated traffic control plan based on result of the comparison.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A computing system for generating and inspecting traffic control management, the computing system comprising:
one or more hardware processors; and
a memory coupled to the one or more hardware processors, wherein the memory comprises a plurality of modules in the form of programmable instructions executable by the one or more hardware processors, wherein the plurality of modules comprises:
a data receiver module configured to receive work zone data for a worksite location from at least one of: one or more user devices and a set of existing worksite resources at the worksite location, wherein the work zone data comprises: worksite location information, Temporary Traffic Control (TTC) information and direction of closure;
a parameter determination module configured to determine one or more traffic control parameters associated with the worksite location based on the received work zone data, prestored guidelines, one or more custom parameters associated with the worksite location and a set of design rules, wherein the prestored guidelines comprise at least one of: Manual on Uniform Traffic Control Devices for Streets and Highways (MUTCD), state, local, utilities and customer guidelines;
a plan generation module configured to automatically generate a traffic control plan for the worksite location based on the received work zone data, the determined one or more traffic control parameters, the prestored guidelines, the one or more custom parameters and the set of design rules, wherein the traffic control plan is an interactive and customizable virtual map of the worksite location indicating at least one of: design layout of the worksite location, one or more worksite resources, locations of the one or more worksite resources, distance between each of the one or more worksite resources, one or more roads connecting the one or more worksite resources, shape and size of the one or more roads, start and stop time of the worksite zone, distance between each of the one or more roads, time of placement of the one or more worksite resources and image recognition of the one or more worksite resources;
a plan deploying module configured to deploy the generated traffic control plan at the worksite location;
a data obtaining module configured to obtain real time worksite information associated with the worksite location upon deployment of the generated traffic control plan via one or more means, wherein the real time worksite information comprises: real-time images of the worksite location, real-time Maintenance of Traffic (MOT) start and stop time, real-time distance between each of the one or more worksite resources and real-time location information of the one or more worksite resources;
an error detection module configured to detect one or more errors in the deployed traffic control plan by validating the deployed traffic control plan based on the prestored guidelines, the one or more custom parameters, the set of design rules, the generated traffic control plan and the obtained real time worksite information;
a recommendation generation module configured to generate one or more recommendations corresponding to the detected one or more errors based on the prestored guidelines, the one or more custom parameters, the set of design rules, the generated traffic control plan and the obtained real time worksite information; and
a data output module configured to output the detected one or more errors and the generated one or more recommendations on user interface screens of the one or more user devices.

2. The computing system of claim 1, wherein in determining the one or more traffic control parameters associated with the worksite location based on the received work zone data, the prestored guidelines, the one or more custom parameters associated with the worksite location and the set of design rules, the parameter determination module is configured to:
retrieve worksite resource information from a traffic control device icon library stored in a storage unit based on the received work zone data, wherein the worksite resource information comprises: one or more device images of one or more traffic control devices placed at the worksite location;
obtain road geometry associated with the one or more roads from a Geographic Information System (GIS);
determine a set of road characteristics associated with the one or more roads based on the obtained geometry of the one or more roads, the prestored guidelines, the one or more custom parameters, the set of design rules and the received work zone data;
determine one or more required traffic control devices and distance between each of the one or more required traffic control devices based on the received work zone data, the prestored guidelines, the one or more custom parameters, the set of design rules and the retrieved worksite resource information;
determine location coordinates of one or more required traffic sign boards based on the received work zone data, the prestored guidelines, the one or more custom parameters and the set of design rules; and
determine the one or more worksite resources, location of the one or more worksite resources and distance between each of the one or more worksite resources based on the received work zone data, the prestored guidelines, the one or more custom parameters, the set of design rules and the retrieved worksite resource information.

3. The computing system of claim 2, wherein in automatically generating the traffic control plan for the worksite location based on the received work zone data, the determined one or more traffic control parameters, the prestored guidelines, the one or more custom parameters and the set of design rules, the plan generation module is configured to:
generate a virtual road design of the one or more roads based on the determined set of road characteristics, the received work zone data, the determined one or more traffic control parameters, the prestored guidelines, the one or more custom parameters and the set of design rules; and
superimpose the generated virtual road design on the design layout of the worksite location, wherein the design layout of the worksite location comprises: warning area, transition area, buffer area, activity area and termination area.

4. The computing system of claim 1, wherein in detecting the one or more errors in the deployed traffic control plan by validating the deployed traffic control plan based on the prestored guidelines, the one or more custom parameters, the set of design rules, the generated traffic control plan and the obtained real time worksite information, the error detection module is configured to:
compare the obtained real time worksite information associated with the worksite location with the prestored guidelines, the one or more custom parameters, the set of design rules and the generated traffic control plan;
determine one or more differences between the obtained real time worksite information and the prestored guidelines, the one or more custom parameters, the set of design rules and the generated traffic control plan based on result of the comparison; and
detect the one or more errors in the deployed traffic control plan based on the determined one or more differences and prestored error information, wherein the determined one or more differences and the detected one or more errors are outputted on user interface screens of the one or more user devices as alerts.

5. The computing system of claim 1, wherein the generated traffic control plan is at least one of: outputted on user interface screens of the one or more user devices, printed via one or more printing devices, converted to one or more other formats and outputted to one or more secondary platforms, wherein the one or more secondary platform comprises: one or more designing tools, one or more navigation applications, travel advisory signs and one or more autonomous vehicles.

6. The computing system of claim 1, further comprises a sign board updating module configured to:
obtain one or more inputs corresponding to traffic at the worksite location via the one or more means upon deploying the generated traffic control plan at the worksite location, wherein the one or more means comprise at least one of: the one or more user devices, the one or more worksite resources, a Global Position System (GPS), a Geographic Information System (GIS), a Radio Frequency Identification (RFID) device, Light Detection and Ranging (LiDAR) and one or more image capturing units;
determine direction of flow of the traffic at real-time based on the obtained one or more inputs; and
automatically update location and direction of one or more required traffic sign boards in the generated traffic control plan.

7. The computing system of claim 1, further comprises a plan updating module configured to:
receive one or more customized inputs corresponding to one or more features of the generated traffic control plan, wherein the one or more inputs are provided by performing one or more actions on the one or more user devices comprising: drag and drop, click, swipe up, swipe down, pinch, click, press and hold, double touch and stretch out and wherein the one or more features of the generated traffic control plan comprise: movement of one or more required traffic control devices, detection of exits, email notification, number of the one or more required traffic control devices, location of the one or more worksite resources, distance between each of the one or more worksite resources and location of the one or more required traffic control devices;
perform one or more customized actions on the generated traffic control plan based on the received one or more customized inputs, wherein the one or more customized actions comprise: updating work site design requirements, updating the one or more worksite resources, adjusting distances between the one or more worksite resources, updating location of each of the one or more worksite resources and updating a set of road characteristics;
update the generated traffic control plan based on the prestored guidelines, the one or more custom parameters and the set of design rules upon performing the one or more customized actions, wherein the updated traffic control plan is at least one of: deployed at the worksite location, outputted on user interface screens of the one or more user devices, printed via one or more printing devices, converted to one or more other formats and outputted to one or more secondary platforms.

8. The computing system of claim 1, wherein the set of existing worksite resources at the worksite location comprise: one or more traffic control devices, one or more traffic sign boards, one or more site crew members, one or more image capturing units, one or more network terminals, one or more roads, road infrastructure and one or more vehicles.

9. The computing system of claim 1, wherein the one or more traffic control parameters comprise: a set of road characteristics of one or more roads, one or more required traffic control devices, distance between each of the one or more required traffic control devices, location coordinates of one or more required traffic sign boards on the one or more roads, the one or more worksite resources required at the worksite location, locations of the one or more worksite resources and distance between each of the one or more worksite resources, wherein the set of road characteristics comprise: type of the one or more roads, shape of the one or more roads, size of the one or more roads, distance between each of the one or more roads, speed limit, shoulder width and lane width.

10. The computing system of claim 1, wherein the one or more recommendations comprise: correct location of the one or more worksite resources, correct distance between each of the one or more worksite resources, correct time stamp, total number of worksite resources one of: required to be added and removed from the worksite location.

11. A method for generating and inspecting traffic control management, the method comprising:
receiving, by one or more hardware processors, work zone data for a worksite location from at least one of: one or more user devices and a set of existing worksite resources at the worksite location, wherein the work zone data comprises: worksite location information, Temporary Traffic Control (TTC) information and direction of closure;
determining, by the one or more hardware processors, one or more traffic control parameters associated with the worksite location based on the received work zone data, prestored guidelines, one or more custom parameters associated with the worksite location and a set of design rules, wherein the prestored guidelines comprise at least one of: Manual on Uniform Traffic Control Devices for Streets and Highways (MUTCD), state, local, utilities and customer guidelines;
automatically generating, by the one or more hardware processors, a traffic control plan for the worksite location based on the received work zone data, the determined one or more traffic control parameters, the prestored guidelines, the one or more custom parameters and the set of design rules, wherein the traffic control plan is an interactive and customizable virtual map of the worksite location indicating at least one of: design layout of the worksite location, one or more worksite resources, locations of the one or more worksite resources, distance between each of the one or more worksite resources, one or more roads connecting the one or more worksite resources, shape and size of the one or more roads, start and stop time of the worksite zone, distance between each of the one or more roads, time of placement of the one or more worksite resources and image recognition of the one or more worksite resources;
deploying, by the one or more hardware processors, the generated traffic control plan at the worksite location;
obtaining, by the one or more hardware processors, real time worksite information associated with the worksite location upon deployment of the generated traffic control plan via one or more means, wherein the real time worksite information comprises: real-time images of the worksite location, real-time Maintenance of Traffic (MOT) start and stop time, real-time distance between each of the one or more worksite resources and real-time location information of the one or more worksite resources;
detecting, by the one or more hardware processors, one or more errors in the deployed traffic control plan by validating the deployed traffic control plan based on the prestored guidelines, the one or more custom parameters, the set of design rules, the generated traffic control plan and the obtained real time worksite information; and
generating, by the one or more hardware processors, one or more recommendations corresponding to the detected one or more errors based on the prestored guidelines, the one or more custom parameters, the set of design rules, the generated traffic control plan and the obtained real time worksite information; and
outputting, by the one or more hardware processors, the detected one or more errors and the generated one or more recommendations on user interface screens of the one or more user devices.

12. The method of claim 11, wherein determining the one or more traffic control parameters associated with the worksite location based on the received work zone data, the prestored guidelines, the one or more custom parameters associated with the worksite location and the set of design rules comprises:
retrieving worksite resource information from a traffic control device icon library stored in a storage unit based on the received work zone data, wherein the worksite resource information comprises: one or more device images of one or more traffic control devices placed at the worksite location;
obtaining road geometry associated with the one or more roads from a Geographic Information System (GIS);
determining a set of road characteristics associated with the one or more roads based on the obtained geometry of the one or more roads, the prestored guidelines, the one or more custom parameters, the set of design rules and the received work zone data;
determining one or more required traffic control devices and distance between each of the one or more required traffic control devices based on the received work zone data, the prestored guidelines, the one or more custom parameters, the set of design rules and the retrieved worksite resource information;
determining location coordinates of one or more required traffic sign boards based on the received work zone data, the prestored guidelines, the one or more custom parameters and the set of design rules; and
determining the one or more worksite resources, location of the one or more worksite resources and distance between each of the one or more worksite resources based on the received work zone data, the prestored guidelines, the one or more custom parameters, the set of design rules and the retrieved worksite resource information.

13. The method of claim 12, wherein automatically generating the traffic control plan for the worksite location based on the received work zone data, the determined one or more traffic control parameters, the prestored guidelines, the one or more custom parameters and the set of design rules comprises:
generating a virtual road design of the one or more roads based on the determined set of road characteristics, the received work zone data, the determined one or more traffic control parameters, the prestored guidelines, the one or more custom parameters and the set of design rules; and
superimposing the generated virtual road design on the design layout of the worksite location, wherein the design layout of the worksite location comprises: warning area, transition area, buffer area, activity area and termination area.

14. The method of claim 11, wherein detecting the one or more errors in the deployed traffic control plan by validating the deployed traffic control plan based on the prestored guidelines, the one or more custom parameters, the set of design rules, the generated traffic control plan and the obtained real time worksite information comprises:
comparing the obtained real time worksite information associated with the worksite location with the prestored guidelines, the one or more custom parameters, the set of design rules and the generated traffic control plan;
determining one or more differences between the obtained real time worksite information and the prestored guidelines, the one or more custom parameters, the set of design rules and the generated traffic control plan based on result of the comparison; and
detecting the one or more errors in the deployed traffic control plan based on the determined one or more differences and prestored error information, wherein the determined one or more differences and the detected one or more errors are outputted on user interface screens of the one or more user devices as alerts.

15. The method of claim 11, wherein the generated traffic control plan is at least one of: outputted on user interface screens of the one or more user devices, printed via one or more printing devices, converted to one or more other formats and outputted to one or more secondary platforms, wherein the one or more secondary platform comprises: one or more designing tools, one or more navigation applications, travel advisory signs and one or more autonomous vehicles.

16. The method of claim 11, further comprises:
obtaining one or more inputs corresponding to traffic at the worksite location via the one or more means upon deploying the generated traffic control plan at the worksite location, wherein the one or more means comprise at least one of: the one or more user devices, the one or more worksite resources, a Global Position System (GPS), a Geographic Information System (GIS), a Radio Frequency Identification (RFID) device, Light Detection and Ranging (LiDAR) and one or more image capturing units;
determining direction of flow of the traffic at real-time based on the obtained one or more inputs; and
automatically updating location and direction of one or more required traffic sign boards in the generated traffic control plan.

17. The method of claim 11, further comprises:
receiving one or more customized inputs corresponding to one or more features of the generated traffic control plan, wherein the one or more inputs are provided by performing one or more actions on the one or more user devices comprising: drag and drop, click, swipe up, swipe down, pinch, click, press and hold, double touch and stretch out and wherein the one or more features of the generated traffic control plan comprise: movement of one or more required traffic control devices, detection of exits, email notification, number of the one or more required traffic control devices, location of the one or more worksite resources, distance between each of the one or more worksite resources and location of the one or more required traffic control devices;
performing one or more customized actions on the generated traffic control plan based on the received one or more customized inputs, wherein the one or more customized actions comprise: updating work site design requirements, updating the one or more worksite resources, adjusting distances between the one or more worksite resources, updating location of each of the one or more worksite resources and updating a set of road characteristics;
updating the generated traffic control plan based on the prestored guidelines, the one or more custom parameters and the set of design rules upon performing the one or more customized actions, wherein the updated traffic control plan is at least one of: deployed at the worksite location, outputted on user interface screens of the one or more user devices, printed via one or more printing devices, converted to one or more other formats and outputted to one or more secondary platforms.

18. The method of claim 11, wherein the set of existing worksite resources at the worksite location comprise: one or more traffic control devices, one or more traffic sign boards, one or more site crew members, one or more image capturing units, one or more network terminals, one or more roads, road infrastructure and one or more vehicles.

19. The method of claim 11, wherein the one or more traffic control parameters comprise: a set of road characteristics of one or more roads, one or more required traffic control devices, distance between each of the one or more required traffic control devices, location coordinates of one or more required traffic sign boards on the one or more roads, the one or more worksite resources required at the worksite location, locations of the one or more worksite resources and distance between each of the one or more worksite resources, wherein the set of road characteristics comprise: type of the one or more roads, shape of the one or more roads, size of the one or more roads, distance between each of the one or more roads, speed limit, shoulder width and lane width.

20. The method of claim 11, wherein the one or more recommendations comprise: correct location of the one or more worksite resources, correct distance between each of the one or more worksite resources, correct time stamp, total number of worksite resources one of: required to be added and removed from the worksite location.
